(19) United States
(12) Patent Application Publication
(10) Pub. No.: US 2002/0050009 A1
(43) Pub. Date: May 2, 2002

(54) Portable travel pillow

(76) Inventor: Jonathan J. Ley, Palatine, IL (US)

Correspondence Address: JONATHAN J. LEY, 1534 CIRCLE LN, PALATINE, IL, 60067, US

(21) Appl. No.: 09/950,532

(22) Filed: Sep. 13, 2001

Related U.S. Application Data
(60) Provisional application No. 60/243,370, filed on Oct. 26, 2000.

(51) Int. Cl. B68G 5/00; A47C 16/00; A47C 20/02

(52) U.S. Cl. 5/657

(57) ABSTRACT

A portable travel pillow is a freestanding, portable device which allows a traveler to rest or sleep comfortably while remaining in a seated position. The travel pillow is comprised of an adjustable tilting facial pad (1-8), an adjustable-length support (9,10,12), two lower leg stands (13) interconnected inside a housing (11,14) and two lower leg pads (16) connected to the leg stands with a ball and cup joint (15). When in use, the bottom of the portable travel pillow is supported by the user's lap, and the top of the travel pillow supports the user's head and neck. When not in use, the portable travel pillow collapses to a compact shape.

### CROSS REFERENCE TO RELATED APPLICATIONS

Not Applicable

### STATEMENT REGARDING FEDERALLY SPONSORED RESEARCH AND DEVELOPMENT

Not Applicable

### BACKGROUND

1. Field of Invention

This invention relates to the field of sleeping-aid or resting-aid devices, specifically, those devices which aid sleep or rest while the user is a seated position.

2. Description of Prior Art

Sedentary travel by definition requires people to remain in one position for extended periods of time. Many travelers would prefer to spend that time asleep, however remaining in a seated position is not normally conducive to comfortable sleep.

Sedentary travelers frequently lean back or to the side in an attempt to sleep. This is not usually effective and can result a sore neck and back.

Common solutions are available to help alleviate these problems. A tilting seat-back is one solution. However, space constraints, especially aboard passenger airplanes, do not allow for sufficient seatback tilt to provide for a comfortable sleep. Horseshoe-shaped neck pillows are another common solution. However, these offer little or no support for the upper body of the user and only minimal support for the user's neck.

Other novel devices have been tried. U.S. Pat. No. 5,611,601 to Cowgur and U.S. Pat. No. 4,235,472 to Sparks describe bulky masses which rest on the user's lap on which the user can lean forward. U.S. Pat. No. 5,645,319 to Parks describes a bulky mass which rests on an airplane tray table, on which the user can lean forward. All of these solutions are too bulky to be considered portable.

U.S. Pat. No. 4,560,201 to Scott describes a strap which connects the wrist, around the back to a headband. This design prevents forward motion of the user's head. However, this solution does nothing to prevent the user from falling to the side.

U.S. Pat. No. 4,565,408 to Palley describes a portable chin rest that attaches to the user's head. This solution is very intrusive, unattractive, and uncomfortable for extended periods of use.

U.S. Pat. No. 973,957 to Neff describes a portable forehead rest and arm rest combination which is supported on a table. This implementation is excessively bulky and requires a sturdy table. Additionally, the apparatus supports the user's forehead and provides no support for the neck. Extended use of this apparatus will strain the user's neck.

U.S. Pat. No. 245,639 to Lay describes a portable forehead rest and arm rest combination supported by the ground. This is also an excessively bulky implementation, and like U.S. Pat. No. 793,957—Neff, it provides no support to the neck.

While some of these approaches may be adequate for some situations, none of them provide the combination of comfort, portability, and simplicity of this invention, the portable travel pillow.

### SUMMARY

The travel pillow is comprised of an adjustable tilting facial pad, an adjustable-length support, and leg pads. When in use, the bottom of the portable travel pillow is supported by the user's lap, and the top of the travel pillow supports the user's head and neck.

### OBJECTS AND ADVANTAGES

The travel pillow is an easy-to-use, comfortable, free-standing, stable, adjustable and portable apparatus which allows the user to sleep or rest in a seated, forward-leaning position. The portable travel pillow is entirely self-contained, its effective use only requires a seat with a seat-back.

### DRAWING FIGURES

FIG. 1 shows a person using the portable travel pillow. Components are not labeled on this figure, as they are fully described in the other figures.

FIG. 2 shows the portable travel pillow in a front view with the front/back tilt at 0 degrees (parallel with the ground) FIG. 3 is a side view of FIG. 2.

FIGS. 4a and 4b are close-up views of the leg joint housing. The leg stands are shown in two different positions.

FIG. 5 is a side view of the collapsed portable travel pillow.

FIG. 6 is a front view of the collapsed portable travel pillow.

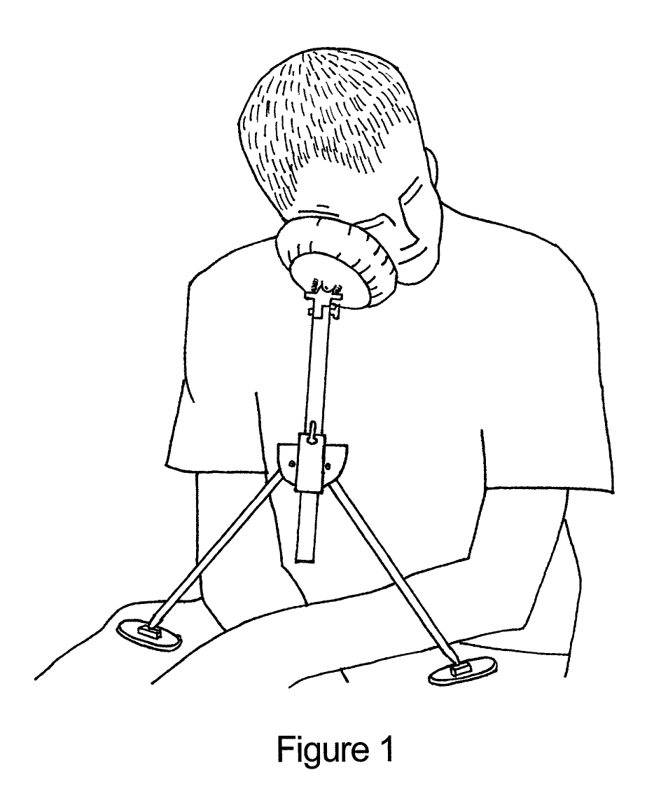

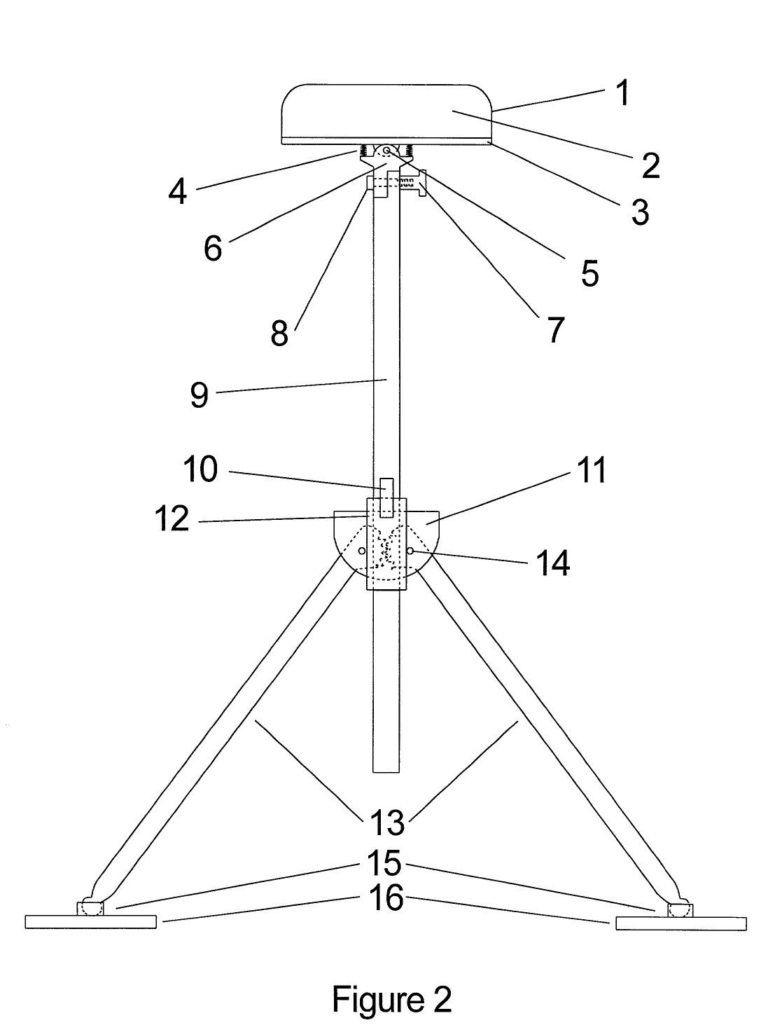

### REFERENCE NUMERALS IN DRAWINGS

1 Facial Pad Covering

2 Facial Pad

3 Facial Pad Support

4 Left/Right Tilt Spring

5 Left/Right Tilt Hinge

6 Front/Back Tilt Support

7 Front/Back Tilt Lock

8 Front/Back Tilt Screw

9 Support Shaft

10 Support Shaft Locking Mechanism

11 Leg Joint Housing

12 Support Shaft Slide

13 Leg Stands

14 Upper Leg Joint Pivot

15 Lower Leg Joint Cup

16 Leg Pads

### DESCRIPTION OF THE DRAWINGS

The facial rest assembly (1,2,3) provides the interface between the travel pillow and the user's head. When in use, the facial pad (2) supports the user's head in a similar manner to that of a pillow. The facial pad (2) is intended to support either side of the user's head, from the lower cheek to the temple. However the best position for the user is the most comfortable position for that particular individual. The facial pad (2) can be made from any soft and supportive material, such as foam or gel, this includes progressively firm foam—stiff on the bottom, soft on top. The facial pad (2) is covered by a removable facial pad covering (1), enabling the user to clean or change the cover. The facial pad covering (1) can be attached to the headrest by any removable means, such as an elastic band, a hook and loop fastener or snaps. Alternatively, the facial pad covering (1) need not be removable in order to function as intended. The facial pad (2) is supported by a firm facial pad support (3). The facial pad support (3) should be large enough to give full support to an adult user. The facial pad support (3) can be contoured so that provides a better ergonomic fit to the user. The contouring would ideally be of a concave, or bowl-shaped design, with the edges pointing upward, so that the shape is more closely aligned with that of the user's head.

The facial rest assembly (1,2,3) is attached to the body of the portable travel pillow via a left/right tilt mechanism (4,5). The left/right tilt mechanism (4,5) allows the facial rest assembly (1,2,3) to tilt either to the left or right approximately 15 degrees from 0 degree tilt. The left/right tilt mechanism (4,5) has a spring (4) loading which returns the left/right tilt hinge (5) to a 0 degree tilt when not in use. The springs (4) are connected on either end to the facial pad support and the front/back tilt support (6). The springs (4) should not be excessively stiff so that it would provide any noticeable resistance to the user's head. The user should be able to tilt the facial rest assembly (1,2,3) to the right or left simply with the weight of the head. This allows the user to shift from resting on the left side of the face to resting on the right side of the face without making any manual adjustments to the portable travel pillow. The left/right tilt mechanism (4,5) can be implemented in any number of ways; such as via a joint with a spring on either side, via a joint with a single center spring or via a rubberized flexible joint. The left/right tilt could also be implemented without a spring, using a simple joint, a notched-joint, or a locking joint, the latter two helping keep the joint's bend-angle stable. Any of these implementations, combinations of these implementations, or other implementations which provide the same effect are within the scope of this invention.

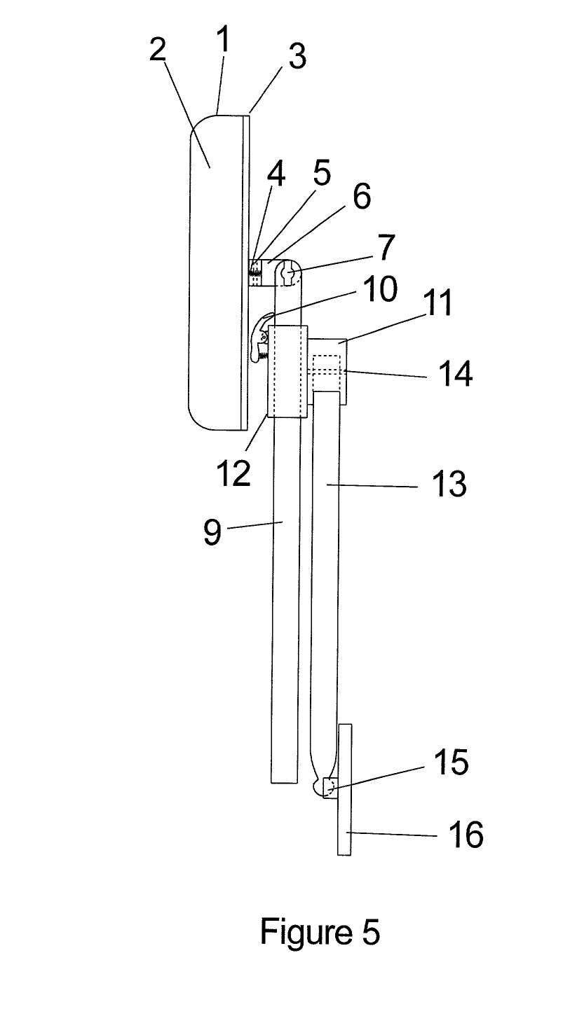

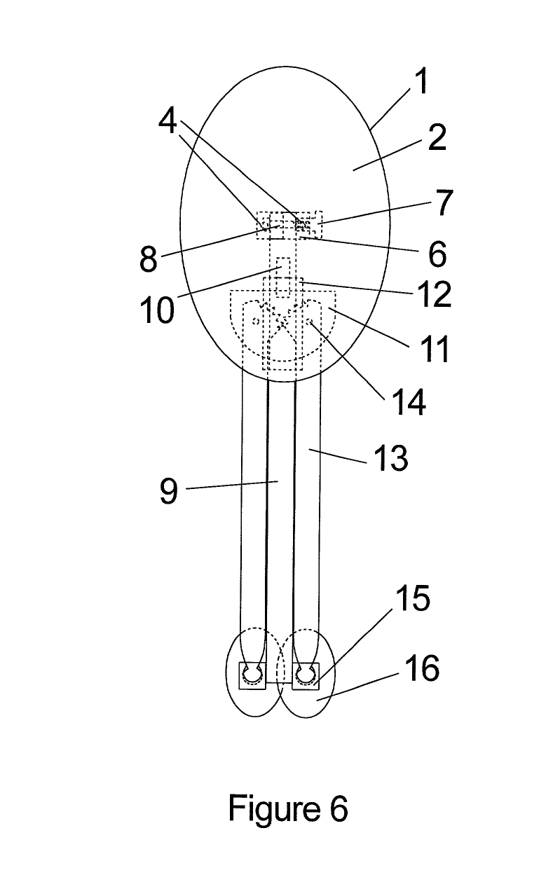

The left/right tilt mechanism (4,5) is attached to the support shaft (9) via a front/back tilt mechanism (6,7,8). This allows the top portion of the portable travel pillow to be tilted into the storage position shown in FIG. 5 and FIG. 6. The front/back tilt mechanism (6,7,8) is comprised of a front/back tilt support (6) and a locking mechanism (7,8). The front/back tilt support (6) supports the top of the portable travel pillow. When in use, the front/back tilt mechanism (6,7,8) should be set at approximately 10 degrees from level. This nominal 10 degree angle is intended to give the user a more comfortable, ergonomic fit when the travel pillow is in use. The front/back tilt locking mechanism (7,8) keeps the headrest in the position the user desires. The front/back tilt locking mechanism (7,8) is comprised of a front/back tilt screw (8) and front/back tilt lock (8). The front/back tilt mechanism (7,8) is locked by turning the front/back tilt lock (7) so that tightens the front/back tilt support (6) to the support shaft (9), preventing movement. The front/back tilt mechanism (6,7,8) can be implemented in any number of ways. The front/back tilt locking mechanism can be a screw which clamps the front/back tilt joint in place as shown in the figures, or it can be a peg-hole design, or it can be a magnetic lock, or it can be a spring-loaded clamp which locks the front/back tilt joint in the desired position. Alternatively, the upper portion of the travel pillow can be designed so that it is removable, thus obviating the need for a front/back tilt mechanism. Any of these implementations, combinations of these implementations, or other implementations which provide the same effect are within the scope of this invention.

The support shaft (9) connects the upper portion of the portable travel pillow. The support shaft should be made of a material stiff enough to prevent bending. The cross-section of the support shaft can be circular, square or of any other geometric design. The support shaft slide (12) should allow movement of the support shaft (9) up and down. A means should be provided to prevent unintended rotational movement of the support shaft (9), either by design of the support shaft locking mechanism (10), the support shaft slide (12), the support shaft (9) itself or any combination thereof. The support shaft should be designed to allow for operation of the support shaft locking mechanism (10), this may require the addition of horizontal grooves or through-holes in the support shaft. The support shaft locking mechanism (10) prevents the support shaft (9) from moving in the downward direction unless intended by the user. One implementation of the support shaft locking mechanism (10) is shown in the figures. In this design, the support shaft (9) is prevented from sliding downward unless the mechanism (10) is depressed by the user. In this design, the support shaft (9) should be grooved or otherwise prepared to provide adequate friction between the support shaft (9) and the locking mechanism (10). Another implementation of the locking mechanism consists of a peg inserted through a hole in the support shaft slide (12) and through any one of a number or corresponding holes in the support shaft (9). The peg could be removed to allow the support shaft to move freely, or inserted to lock it into position. The peg could either be a removable separate piece, or attached to the support shaft slide. Another implementation of the locking mechanism would be a screw which when turned would decrease the diameter of the support shaft slide, thereby locking the support shaft in place. Any of these implementations, combinations of these implementations, or other implementations which provide the same effect are in the scope of this invention.

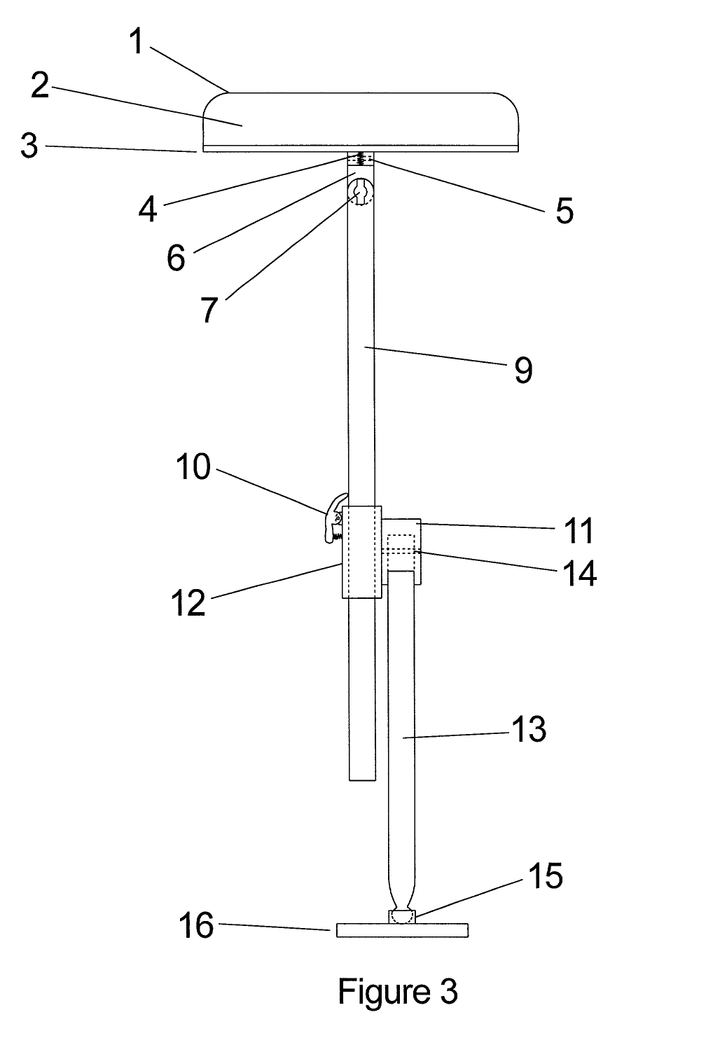

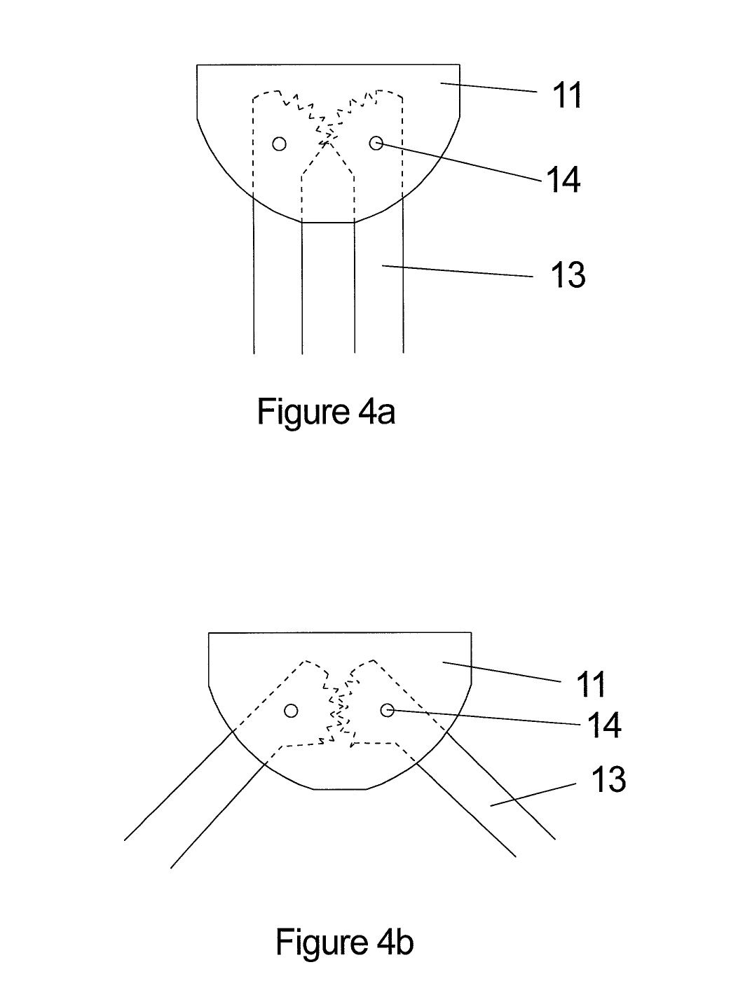

The support shaft slide (12) is attached to the leg joint housing (11). The leg joint housing (11) is open on the sides and bottom to allow movement of the leg stands (13). The leg stands (13) are attached to the leg joint housing (11) by the upper leg joint pivot (14). The leg stands (13) must move in a dependent manner. That is, if one leg stand (13) is moved by the user, the other should automatically move to the same angle in the opposite direction. The purpose of this is to provide stability to the portable travel pillow when in use. FIG. 4a and 4b show an enlarged view of a gearing mechanism (11,13,14) which provides this function. FIG. 4a shows the leg stands (13) together, in the storage position. FIG. 4b shows the leg stands (13) apart in the in-use position. This function can be implemented in a number of ways. For example, most common designs of a mechanical drawing compass show alternate implementations. Further, the common design of the umbrella support shaft and tine slide shows another possible implementation.

The leg stands (13) connect the leg pads (16) to the leg joint housing (11) and consequently to the rest of the portable travel pillow. The legs should be stiff enough to provide support without bending. The cross section of the leg stands (13) can be of any geometric design. Modifications to the leg stands (13) may be required depending on the design of the leg joint housing (11) or any alternative design which provides the same function as the gearing mechanism described above.

The lower leg joint cup (15) provides a flexible interface between the leg stands (13) and the leg pads (16). The lower leg joint cup (15) combined with the rounded end of the leg stand (13) acts as a ball-cup joint. This allows free movement of the leg pads (16) while keeping the legs pads firmly secured to the user's lap. The design of the lower leg joint cup (15) is open on one side, such that it allows the leg pads (16) to be folded up to a position perpendicular to the leg stands (13) when the travel pillow is not in use. This is most clearly illustrated in FIG. 5 and FIG. 6. Alternative designs of the lower leg joint could include a simple flexible (rubberized) attachment between the leg pads (16) and the leg stands (13). A simpler joint could also be used, this would not provide the flexibility of the ball-joint, but may be an adequate alternative. Alternately, the leg pads (16) could be made detachable. Another alternative would allow the legs pads to slide toward the center of the portable travel pillow when not in use. This would allow the collapsed portable travel pillow to achieve a smaller profile. Any of these implementations, combinations of these implementations, or other implementations which provide the same effect are within the scope of this invention.

The leg pads (16) are intended to rest upon the user's lap. They are comprised of a stiff material. The bottom of the legs pads should be covered with a non-skid surface, such as a textured rubber, in order to prevent slippage of the travel pillow from the user's legs. The bottom surface area of the leg pads should be only large enough to provide a comfortable fit to the user of the travel pillow. One possible alternative design would replace the lower let joint cup (15) and leg pads (16) with a leg stub. This leg stub would be similar to that found on the bottom of a cane. The bottom of the leg stub could be convex-shaped to provide a comfortable, secure and non-slip interface to the user's legs.

Advantages

The portable travel pillow has a number of advantages over existing solutions:

(a) The portable travel pillow is easy to use. The operation is generally intuitive, and takes seconds to set up.

(b) The shape of the portable travel pillow is ergonomically sound. The facial pad is contoured to support the user's head and neck much like a pillow. The left/right tilt allows the user to turn their head comfortably left to right without any manual adjustment. The front/back tilt allows fine-tuning of fit.

(c) The portable travel pillow is completely self-contained, requiring only a seat with a back for most effective use.

(d) By means of the lower leg joints, the upper leg joint, the support shaft slide and the front/back tilt, the portable travel pillow is easily adjustable to fit the size and shape of any user.

(e) The portable travel pillow is small and easy to carry when not in use. It can be made of lightweight materials, thereby not burdening the user when not in use.

Operation

The portable travel pillow is used by the following steps:

(a) Open the leg stands, and place the leg pads on the legs.

(b) Adjust the height so the top of the facial pad is even with the bottom of the chin.

(c) Lock the front/back tilt mechanism to a comfortable angle, usually about 10 degrees from level.

(d) Lean forward, keeping the lower back firm against the seatback.

(e) Arms can be placed either between the leg stands or on top of the leg stands.

When in use, the portable travel pillow completely supports the upper body of the user. The user can completely relax the upper body and remain in a stable position. The weight of the user's upper body is supported by the user's seat and seat-back, the portable travel pillow, and the user's arms. This distribution of weight creates a stable and comfortable system.

The facial pad on the portable travel pillow tilts left or right with the weight of the user, no manual adjustment is required. This tilt, along with the front/back tilt allows for an ergonomic position of the user's head similar to the position the user's head would assume when resting on a pillow.

The portable travel pillow can be collapsed to a portable size by the following steps:

(a) Lock the front/back tilt mechanism to an angle parallel with the support shaft.

(b) Adjust the height of the support shaft to its minimum.

(c) Close the leg stands, and fold up the leg pads to an angle parallel with the leg stands.

The portable travel pillow can then be carried by hand, attached to luggage, or fit inside a briefcase.

Conclusions, Ramifications, and Scope

The reader will see that the portable travel pillow of this invention is a novel solution to an existing problem, and an improvement over existing solutions. The portable travel pillow is an improvement in that it combines features of comfort, portability, ease of use, adjustability and simplicity that are found in no other solution.

The facial support is ergonomically designed for comfort and ease of use.

All elements of the portable travel pillow can be collapsed for portability.

The overall height and leg-width are fully adjustable to fit any user.

The design is simple and easy to use.

The description above contains many specific implementations of various parts of the portable travel pillow. For example, the design of many of the joints can be changed from the description without altering the function of the portable travel pillow. These specific descriptions should not limit the scope of this invention, as they do not affect the function of the portable travel pillow as it pertains to the user.

I claim:

1. A freestanding portable device comprising:
(a) A padded headrest supported by a rigid material. Said padded headrest and rigid material being of sufficient size to comfortably support the side of a head of a human.
(b) One upper support shaft attached to said rigid material at the upper end of said upper support shaft.
(c) One housing through which said upper support shaft can slide vertically only when such sliding is desired.
(d) Two lower support shafts connected by a joint to said housing and interconnected within said housing such that said lower support shafts move in a dependent manner with respect to one another.
(e) Two lower leg pads comprised of a rigid material and connected to said lower support shafts in a manner so said lower leg pads can remain at a stationary angle relative to ground while said lower leg support shafts move in said housing as described heretofore.
